(19) United States
(12) Patent Application Publication
(10) Pub. No.: US 2019/0156984 A1
(43) Pub. Date: May 23, 2019

(54) TRANSFORMER STRUCTURE

(71) Applicant: TAI-TECH ADVANCED ELECTRONICS CO., LTD., TAOYUAN CITY (TW)

(72) Inventors: MING-YEN HSIEH, TAOYUAN CITY (TW); HSIANG-CHUNG YANG, TAOYUAN CITY (TW); CHIN-CHENG LIN, TAOYUAN CITY (TW)

(21) Appl. No.: 15/821,707

(22) Filed: Nov. 22, 2017

(51) Int. Cl. H01F 27/24; H01F 27/29

(52) U.S. Cl. CPC H01F 27/24; H01F 27/29

(57) ABSTRACT

A transformer structure includes an iron core and coils constituted by first, second, third and fourth windings, where the iron core has a first, second and middle flanges. The first flange is respectively configured with first and second terminal electrodes, the second flange third and fourth terminal electrodes, and the middle flange first and second center taps. The first winding is respectively in connection with the first terminal electrode and first center tap, the second winding the first center tap and third terminal electrode, the third winding the second terminal electrode and second center tap, and the fourth winding the second center tap and fourth terminal electrode. Whereby, the present invention can obviously increase the Hi-Pot safety distance of the transformer, and can thus have better high-pressure resistance.

### TECHNICAL FIELD OF THE INVENTION

The present invention relates to a transformer structure.

### DESCRIPTION OF THE PRIOR ART

A conventional transformer structure, as FIG. 1 shows, is configured with a pair of primary-side terminal electrodes 12a , 12b and a secondary-side center tap 12c on a first flange 10 formed on one side of a drum core, and a pair of secondary-side terminal electrodes 13a , 13b and a primary-side center tap 13c on a second flange 11 formed on another side thereof In addition, a pair of coils of the transformer are constituted by four windings C1 to C4, where the windings C1 and C2 are constituted into a primary-side coil, and the windings C3 and C4 a secondary-side coil; the two ends of the winding C1 are respectively connected to the primary-side terminal electrode 12a and primary-side center tap 13c , the two ends of the winding C2 the primary-side terminal electrode 12b and primary-side center tap 13c, the two ends of the winding C3 the secondary-side center tap 12c and secondary-side terminal electrode 13b , and the two ends of the winding C4 the secondary-side center tap 12c and secondary-side terminal electrode 13a.

Referring to FIG. 1 again, the distance between the primary-side terminal electrode 12b and secondary-side center tap 12c accordingly is the distance between the primary-side coil and secondary-side coil. The distance mentioned above obviously is smaller than the length of the first flange 10 such that the pressure safety distance (also known as high potential (Hi-Pot) safety distance) of the transformer obviously is smaller on the premise that the size thereof is fixed, resulting in the poorer high pressure resistance thereof. In addition, the transformer structure disclosed by Taiwan Patent No. M531040 also has the same problem

### SUMMARY OF THE INVENTION

To overcome the defects mentioned above, the present invention is proposed.

One object of the present invention is to provide a transformer structure, having a better high-pressure resistance.

To achieve the object mentioned above, the present invention proposes a transformer structure, including: an iron core, having a wound portion and a pair of first flange and second flange respectively in connection with two ends of the wound portion, two sides of a top face of the first flange respectively configured with a first terminal electrode and second terminal electrode, two sides of a top face of the second flange a third terminal electrode and fourth terminal electrode in the same direction order, a middle flange extended out from a middle position of the wound portion of the iron core, and two sides of a top face of the middle flange respectively configured with a first center tap and second center tap in the same direction order; a first winding, wound around the wound portion, a first end and second end of the first winding respectively in connection with the first terminal electrode and first center tap; a second winding, wound around the wound portion, a first end and second end of the second winding respectively in connection with the first center tap and third terminal electrode; a third winding, wound around the wound portion, a first end and second end of the third winding respectively in connection with the second terminal electrode and second center tap; and a fourth winding, wound around the wound portion, a first end and second end of the fourth winding respectively in connection with the second center tap and fourth terminal electrode.

According to the transformer structure mentioned above, it further includes a cover plate combined and fixed with a bottom face of each flange of the iron core.

According to the transformer structure mentioned above, the first winding and second winding are wound in the same direction as the third winding and fourth winding.

According to the transformer structure mentioned above, the first winding and second winding are wound in a direction opposite to the third winding and fourth winding.

With the structure mentioned above, the present invention can obviously increase the Hi-Pot safety distance of a transformer, and can thus have better high-pressure resistance so as to improve the practicality of the present invention substantially.

### BRIEF DESCRIPTION OF THE DRAWINGS

FIG. 1 is a schematically cross-sectional view of a conventional transformer structure;

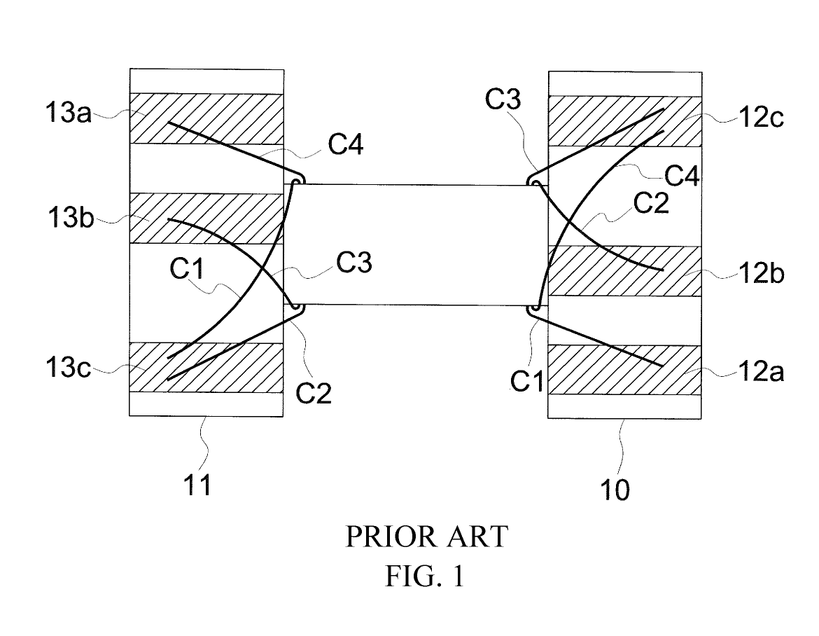

FIG. 2 is a perspective view of a preferred embodiment of the present invention;

FIG. 3 is a top view of the embodiment of the present invention;

FIG. 4 is an equivalent circuit diagram of the embodiment of the present invention; and

FIG. 5 is a perspective view of another preferred embodiment of the present invention.

### DETAILED DESCRIPTION OF THE PREFERRED EMBODIMENTS

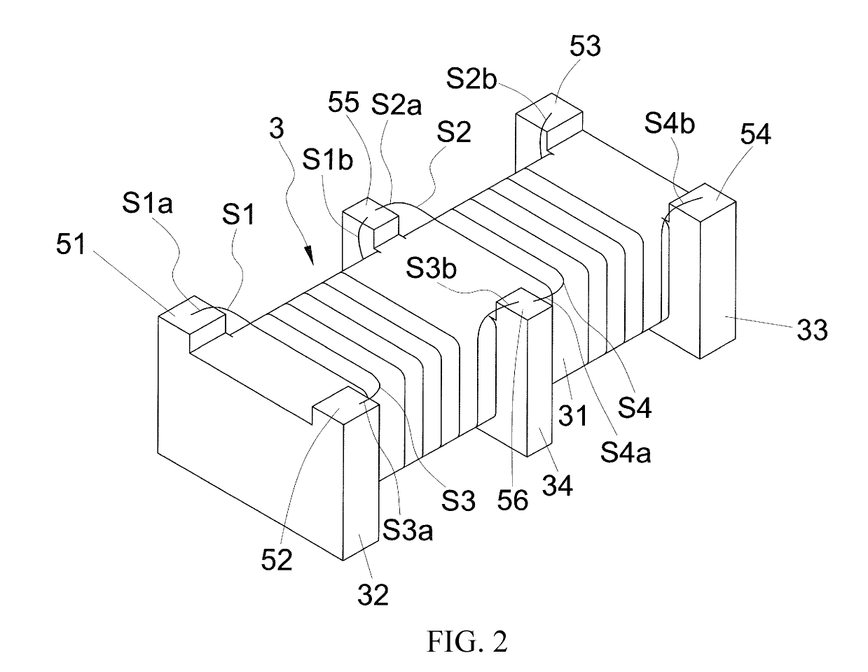

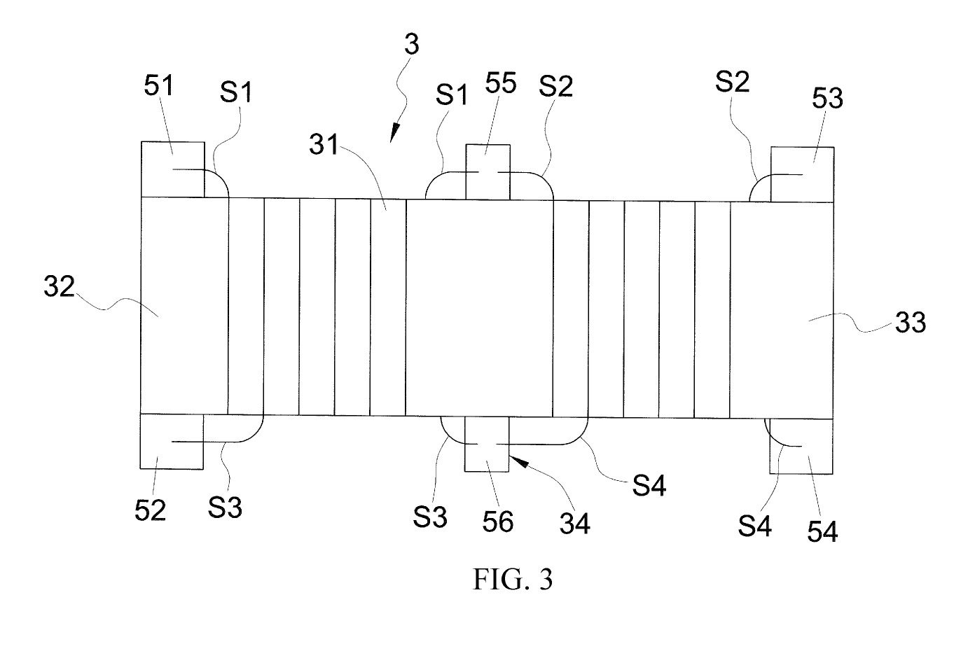

Referring to FIGS. 2 and 3, a transformer structure of the present invention, in a preferred embodiment, includes: an iron core 3, having a wound portion 31 and a first flange 32 and second flange 33 respectively in connection with the two ends of the wound portion 31, the two sides of the top face of the first flange 32 respectively configured with a first terminal electrode 51 and second terminal electrode 52, the two sides of the top face of the second flange 33 a third terminal electrode 53 and fourth terminal electrode 54 in the same direction order, a middle flange 34 extended out from the middle of the wound portion 31 of the iron core 3, and the two sides of the top face of the middle flange 34 respectively configured with a first center tap 55 and second center tap 56 in the same direction order, where each terminal electrode and each center tap may specifically be made of conductive silver paste; a first winding 51, wound around the wound portion 31 of the iron core 3, and a first end S1a and second end S1b thereof respectively in connection with the first terminal electrode 51 and first center tap 55; a second winding S2, wound around the wound portion 31 of the iron core 3, and a first end S2a and second end S2b thereof respectively in connection with the first center tap 55 and third terminal electrode 53; a third winding S3, wound around the wound portion 31 of the iron core 3, and a first end S3a and second end S3b thereof respectively in connection with the second terminal electrode 52 and second center tap 56; and a fourth winding S4, wound around the wound portion 31 of the iron core 3, and a first end S4a and second end S4b thereof respectively in connection with the second center tap 56 and fourth terminal electrode 54.

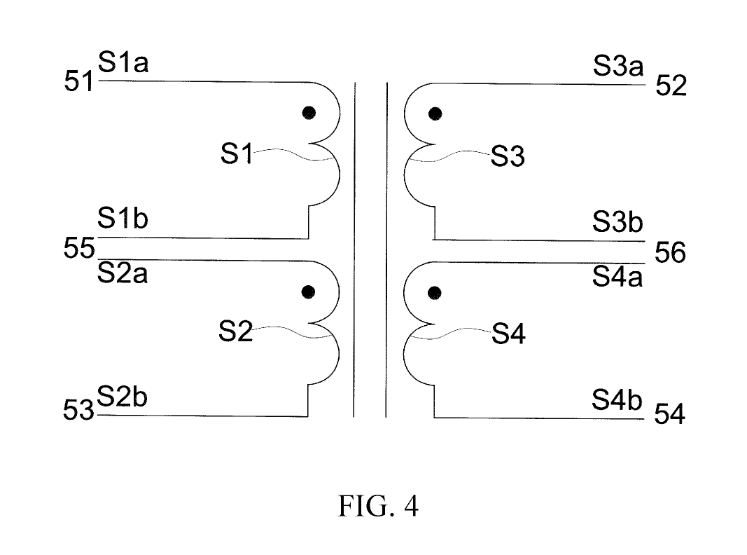

Referring to FIG. 4, which is an equivalent circuit diagram of the embodiment of the transformer structure of the present invention, the first winding S1 and second winding S2, as far as the present invention is concerned, constitute a primary-side coil of the transformer, the third winding S3 and fourth winding S4 then constitute a secondary-side coil thereof, the first terminal electrode 5a and third terminal electrode 53 are formed into two primary-side input ends, the second terminal electrode 52 and fourth terminal electrode 54 is then formed into two secondary-side output ends, and the first center tap 55 and second center tap 56 are respectively used as primary-side and secondary-side center taps.

In addition, it may be mentioned that upon actual winding work, if the first winding Si and second winding S2 used as the primary-side coil of the transformer are wound in a first winding (forward) direction, the third winding S3 and fourth winding S4 used as the secondary-side coil may then similarly be wound in the first winding direction, or may also be wound in a second winding (i.e. reverse) direction opposite to the first winding direction.

Referring to FIGS. 2 and 3, with the above transformer structure, the distance between the primary-side coil and secondary-side coil of the transformer of the present invention accordingly is the distance between the first center tap 55 and second center tap 56, which is equal to the length of the entire middle flange 34. In this way, the present invention can obviously increase the Hi-Pot safety distance under the condition of the transformer being fixed in size compared to conventional transformers. Thus, the present invention can have better high-pressure resistance.

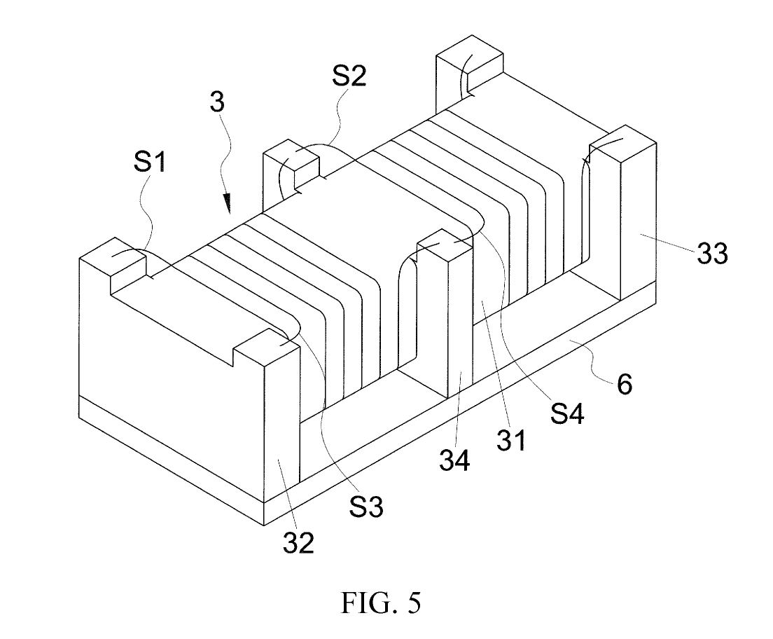

Referring to FIG. 5, the transformer structure of the present invention, in another preferred embodiment, further includes a cover plate 6 respectively combined and fixed with the bottom faces of the flanges, i.e. the first flange 32, second flange 33 and middle flange 34, for example by means of cementation, thereby allowing the transformer of the present invention to have a higher inductance and be conveniently drawn in by surface mount technology (SMT) equipment upon installment.

I claim:

1. A transformer structure, comprising:
an iron core, having a wound portion and a pair of first flange and second flange respectively in connection with two ends of said wound portion, two sides of a top face of said first flange respectively configured with a first terminal electrode and second terminal electrode, two sides of a top face of said second flange a third terminal electrode and fourth terminal electrode in the same direction order, a middle flange extended out from a middle position of said wound portion of said iron core, and two sides of a top face of said middle flange respectively configured with a first center tap and second center tap in the same direction order;
a first winding, wound around said wound portion, a first end and second end of said first winding respectively in connection with said first terminal electrode and first center tap;
a second winding, wound around said wound portion, a first end and second end of said second winding respectively in connection with said first center tap and third terminal electrode;
a third winding, wound around said wound portion, a first end and second end of said third winding respectively in connection with said second terminal electrode and second center tap; and
a fourth winding, wound around said wound portion, a first end and second end of said fourth winding respectively in connection with said second center tap and fourth terminal electrode.

2. The structure according to claim 1, further comprising a cover plate combined and fixed with a bottom face of each said flange of said iron core.

3. The structure according to claim 1, wherein said first winding and second winding are wound in the same direction as said third winding and fourth winding.

4. The structure according to claim 1, wherein said first winding and second winding are wound in a direction opposite to said third winding and fourth winding.
